(19) United States
(12) Patent Application Publication
(10) Pub. No.: US 2022/0366223 A1
(43) Pub. Date: Nov. 17, 2022

(54) A METHOD FOR UNCERTAINTY ESTIMATION IN DEEP NEURAL NETWORKS

(71) Applicants: THE UAB RESEARCH FOUNDATION, Birmingham, AL (US); ROWAN UNIVERSITY, Glassboro, NJ (US)

(72) Inventors: Hassan Fathallah-Shaykh, Vestavia Hills, AL (US); Nidhal Bouaynaya, Voorhees, NJ (US); Ghulam Rasool, Mickleton, NJ (US); Dimah Dera, Glassboro, NJ (US)

(21) Appl. No.: 17/764,133

(22) PCT Filed: Sep. 30, 2020
(86) PCT No.: PCT/US20/53441

§ 371 Date: Mar. 25, 2022

Related U.S. Application Data
(60) Provisional application No. 62/912,914, filed on Oct. 9, 2019.
(60) Provisional application No. 63/016,593, filed on Apr. 28, 2020.

(51) Int. Cl. G06N 3/04

(52) U.S. Cl. CPC G06N 3/0481

(57) ABSTRACT

Disclosed are various approaches for estimating uncertainty in deep neural networks. A respective tensor normal distribution can be applied to each of a plurality of convolutional kernels of a convolutional neural network, wherein the respective tensor normal distribution captures a correlation and a variance heterogeneity of each of the plurality of convolutional kernels. Then, the mean and covariance of each respective tensor normal distribution passing through the non-linear activation function of each nonlinear perceptron can be approximated. Next, a max-pool operation can be performed on a plurality of outputs of the plurality of non-linear perceptrons to generate an output tensor. Then, the output tensor can be vectorized to create an input vector for a fully-connected layer of the convolutional neural network. Subsequently, an output vector can be generated using the fully-connected layer. Then, a mean matrix and a covariance matrix for the output vector can be computed.

### CROSS-REFERENCE TO RELATED APPLICATIONS

This application claims priority to, and the benefit of, U.S. Provisional Patent Application 63/016,593, entitled “Method for Uncertainty Estimation in Deep Neural Networks” and filed on Apr. 28, 2020, which is incorporated by reference as if set forth herein in its entirety.

This application also claims priority to, and the benefit of, U.S. Provisional Patent Application 62/912,914, entitled “A Method for Uncertainty Estimation in Deep Neural Networks” and filed on Oct. 9, 2019, which is incorporated by reference as if set forth herein in its entirety.

### GOVERNMENT SUPPORT CLAUSE

This invention was made with government support under ECCS-1903466 and CCF-1527822 awarded by the National Science Foundation. The government has certain rights in the invention.

### BACKGROUND

Machine-learning is commonly used to make predictions based on data provided to a machine-learning model. These machine-learning models are commonly trained using large datasets with known, correct predictions for a given input. The result is that the machine-learning model can improve its predictive abilities as it is trained using larger volumes of data. However, while the machine-learning model can provide a prediction, machine-learning models are generally not able to quantify the confidence of the accuracy or correctness of their predictions. For example, a machine-learning model may be trained to identify objects in images, but may not be able to provide quantification of how confident it is in identifying an object. As a simple example, a machine-learning model could state that there is a 98% chance that an object in an image is an animal, but is unable to state how confident it is in its prediction (e.g., 50% confidence in the accuracy of the prediction, 75% confident in the accuracy of the prediction, etc.).

### SUMMARY

Various embodiments of the present disclosure include a system, comprising: a computing device comprising a processor and a memory; a convolutional neural network stored in the memory, the convolutional neural network comprising a plurality of non-linear perceptrons, each non-linear perceptron comprising a non-linear activation function; and machine readable instructions stored in the memory that, when executed by the processor, cause the computing device to at least: apply a respective tensor normal distribution to each of a plurality of convolutional kernels of the convolutional neural network, wherein the respective tensor normal distribution captures a correlation and a variance heterogeneity of each of the plurality of the convolutional kernels; approximate the mean and covariance of each respective tensor normal distribution passing through the non-linear activation function of each non-linear perceptron; perform a max-pool operation on a plurality of outputs of the plurality of non-linear perceptrons to generate an output tensor; vectorize the output tensor to create an input vector for a fully-connected layer of the convolutional neural network; generate an output vector using the fully-connected layer; and compute a mean matrix and a covariance matrix for the output vector. In one or more embodiments, the machine-readable instructions, when executed by the processor, further cause the computing device to at least: supply the output vector to a softmax function to make a prediction; and compute a confidence in the prediction based at least in part on the mean matrix and the covariance matrix of the output vector. In one or more embodiments, the machine-readable instructions that cause the computing device to approximate the mean and covariance of each respective tensor normal distribution passing through the non-linear activation function of each non-linear perceptron utilize a Taylor series first-order approximation. In one or more embodiments, the machine-readable instructions that cause the computing device to approximate the mean and covariance of each respective tensor normal distribution passing through the non-linear activation function of each non-linear perceptron utilize a Monte Carlo expansion. In one or more embodiments, the machine-readable instructions that cause the computing device to approximate the mean and covariance of each respective tensor normal distribution passing through the non-linear activation function of each non-linear perceptron utilize a wavelet.

Various embodiments of the present disclosure include a method, comprising applying a respective tensor normal distribution to each of a plurality of convolutional kernels of a convolutional neural network, wherein the respective tensor normal distribution captures a correlation and a variance heterogeneity of each of the plurality of convolutional kernels; approximating the mean and covariance of each respective tensor normal distribution passing through the non-linear activation function of each non-linear perceptron; performing a max-pool operation on a plurality of outputs of the plurality of non-linear perceptrons to generate an output tensor; vectorizing the output tensor to create an input vector for a fully-connected layer of the convolutional neural network; generating an output vector using the fully-connected layer; and computing a mean matrix and a covariance matrix for the output vector. In one or more embodiments, the method can further include supplying the output vector to a softmax function to make a prediction; and computing a confidence in the prediction based at least in part on the mean matrix and the covariance matrix of the output vector. In one or more embodiments, approximating the mean and covariance of each respective tensor normal distribution passing through the non-linear activation function of each non-linear perceptron is based at least in part on a Taylor series first-order approximation. In one or more embodiments, approximating the mean and covariance of each respective tensor normal distribution passing through the non-linear activation function of each non-linear perceptron is based at least in part on a Monte Carlo expansion. In one or more embodiments, approximating the mean and covariance of each respective tensor normal distribution passing through the non-linear activation function of each non-linear perceptron is based at least in part on a wavelet.

Various embodiments of the present disclosure include a non-transitory, computer-readable medium comprising machine-readable instructions that, when executed by a processor of a computing device, cause the computing device to at least: apply a respective tensor normal distribution to each of a plurality of convolutional kernels of a convolutional neural network, wherein the respective tensor normal distribution captures a correlation and a variance heterogeneity of each of the plurality of convolutional kernels; approximate the mean and covariance of each respective tensor normal distribution passing through the non-linear activation function of each non-linear perceptron; perform a max-pool operation on a plurality of outputs of the plurality of non-linear perceptrons to generate an output tensor; vectorize the output tensor to create an input vector for a fully-connected layer of the convolutional neural network; generate an output vector using the fully-connected layer; and compute a mean matrix and a covariance matrix for the output vector. In one or more embodiments, the machine-readable instructions, when executed by the processor, further cause the computing device to at least: supply the output vector to a softmax function to make a prediction; and compute a confidence in the prediction based at least in part on the mean matrix and the covariance matrix of the output vector. In one or more embodiments, the machine-readable instructions that cause the computing device to approximate the mean and covariance of each respective tensor normal distribution passing through the non-linear activation function of each non-linear perceptron utilize a Taylor series first-order approximation. In one or more embodiments, the machine-readable instructions that cause the computing device to approximate the mean and covariance of each respective tensor normal distribution passing through the non-linear activation function of each non-linear perceptron utilize a Monte Carlo expansion. In one or more embodiments, the machine-readable instructions that cause the computing device to approximate the mean and covariance of each respective tensor normal distribution passing through the non-linear activation function of each non-linear perceptron utilize a wavelet.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting one of several embodiments of the present disclosure.

FIG. 2 is a drawing depicting one of several embodiments of the present disclosure.

### DETAILED DESCRIPTION

Deep neural networks are being explored extensively in the medical imaging domain for various computer vision tasks including disease classification, object detection as well as pixel-level segmentation. However, due to the very nature of these algorithms, it is well known that the prediction/inference decisions produced by these algorithms are not calibrated, i.e., these algorithms do not provide a measure of confidence in their predictions. For critical applications, machine learning algorithms must provide a calibrated measure of confidence in their prediction.

The estimation of uncertainty or confidence in the output decisions of deep neural networks (DNNs) is pivotal for their deployment in real-world scenarios. In modern applications, including autonomous driving and medical diagnosis, the reliability of the predicted decision and the robustness of the model to input noise are crucial. Bayesian probability theory provides a principled approach to reason about the uncertainty of a model, including DNNs. In the Bayesian framework, model parameters, i.e., the weights and biases, are defined as random variables with a prior probability distribution. All information about the parameters can be found in their posterior distribution given the observed data. The posterior distribution is then used to find the predictive distribution of new data by marginalizing out the parameters. However, posterior inference in DNNs is analytically intractable and approximations such as variational inference (VI) are often used. Recent work has shown that VI approximation can be scaled to large and modern DNN architectures. However, the challenge remains, i.e., the propagation of distributions introduced over the weights through multiple layers (consisting of linear and nonlinear transformations) of DNNs.

For example, there are a number of proposed frameworks for estimating the variance of fully-connected neural networks. However, in all of these approaches, the second moment (covariance matrix) of the weights is not propagated from one layer of the neural network to the next layer. The uncertainty of the network output is estimated at the test time using Monte Carlo runs by sampling from the estimated distribution of weights. Recent approaches proposed for model uncertainty considered only the fully-connected network and limited choice of activation function such as (ReLU, leaky ReLU and/or Heaviside functions). However, none of the recent methods for propagating model uncertainty considered a CNN or a recurrent neural network with a general choice of activation function, which enables flexibility in extending the framework for various network architecture and different datasets.

To solve these problems, various embodiments of the present disclosure involve an extended VI (eVI) approach for propagating model uncertainty in CNN. The convolutional kernels are considered as random tensors and their first and second moments are propagated through all layers (convolution, max-pooling and fully-connected). The covariance of the predictive distribution, which represents the uncertainty associated with the prediction, is the covariance of the distribution of the weights propagated through layers of the CNN. Accordingly, various embodiments of the present disclosure involve introducing tensor Normal distributions (TNDs) over convolutional kernels. TNDs capture the correlation and variance heterogeneity, both within and among dimensions. Various embodiments also involve approximating the means and covariances of the TNDs after propagating them through nonlinear activation functions using a Taylor series or other approaches (e.g. Monte Carlo expansions, wavelets, etc.). Propagation of moments through layers of CNN make it robust to noise (additive, inherent or adversarial) in the data as well as variations in the model parameters (kernels). Experimental results showing superior robustness of eVI-CNN against Gaussian noise and adversarial attacks on MNIST and CIFAR-10 datasets.

A neural network can be viewed as a probabilistic model p(y|X,Ω): given an input XϵR^{I}^{₁}^{×I}^{₂}^{×K}, the neural network assigns a probability distribution to each possible output y, using the set of weights Ω. The weight parameters define all network layers, Ω={{{ [symbol] ^{(k}^{₁}⁾}ₖ_{_{c}}₌₁^{K}^{_{c}}}_{c=1}^{C},{W^{(l)}}ₗ₌₁^{L}}, where {{ [symbol] ^{(k}^{_{c}}⁾}ₖ_{ₙ}₌ₗ^{K}^{_{c}} }_{c=1}^{C} is the set of C convolutional layers with K_{c} kernels in the c^{th} convolutional layer, and {W^{(l)}}ₗ₌₁^{L} is the set of L fully-connected layers.

In a deterministic setting, the optimal weights are obtained by maximizing the likelihood p( [symbol] )Ω) given the training data [symbol] ={ [symbol] ⁽ⁱ⁾,y⁽ⁱ⁾}ᵢ₌₁^{N} or by maximizing the posterior p(Ω| [symbol] ), where the prior distribution is considered as a regularization term. The likelihood distribution p(y| [symbol] ,Ω), in deterministic models, is generally, the cross-entropy loss for classification problems or squared loss for regression problems, and network parameters are updated through back-propagation.

For instance, given a prior distribution Ω˜p(Ω) over network parameters. By estimating the posterior distribution of the weights given the data p(Ω| [symbol] ), the predictive distribution of any new unseen data point [symbol] can be found:

p(\tilde{y}| [symbol] , [symbol] )=∫p(\tilde{y}| [symbol] ,Ω)p(Ω| [symbol] )dΩ. (1)

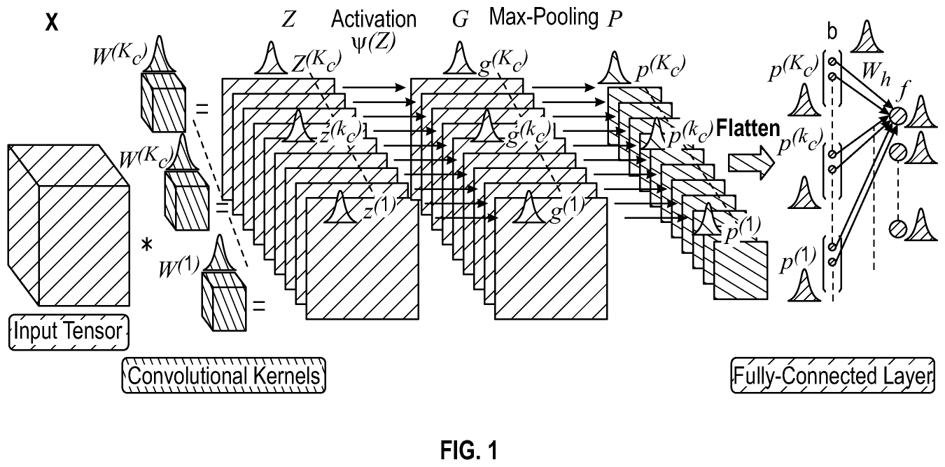

An illustration of a probabilistic convolutional neural network with one convolutional layer, max-pooling and one fully connected layer is shown in FIG. 1.

Tensor Normal Distribution

A fully factorized Gaussian distribution defined over the kernel tensor imposes a restrictive independent assumption between the kernel elements. Instead, TNDs can be used, which are defined over n-dimensional arrays. Specifically, a TND of order 3 is defined as [symbol] ˜ [symbol] ₙ_{₁}_{,n}_{₂}_{,n}_{₃}( [symbol] , [symbol] ), where [symbol] =[ [symbol] ], and [symbol] is the covariance tensor of order six. It can be shown that this covariance tensor is positive semi-definite. In a separable or Kronecker structured model, the covariance matrix of the vectorized multi-dimensional array is the Kronecker product of covariance matrices equal to the number of dimensions, e.g., [symbol] =⊗ⱼ₌₃¹U^{(j)}, where {U^{(j)}}ⱼ₌₁³ϵ [symbol] ⁿ^{ⱼ}^{×n}^{ⱼ} are positive semi-definite matrices. This factorization reduces the number of parameters to be estimated. In a separable model, an equivalent formulation of the TND is essentially a multivariate Gaussian distribution, i.e.,

$$\text{?} \qquad ( 2 )$$

$$\text{?} \text{indicates text missing or illegible when filed}$$

where vec(·) denotes the vectorization operation. We assume that convolutional kernels are independent of each other within as well as across layers. The independence assumption allows convolutional layers to extract independent features within and across layers in a CNN.

VI with Tensor Normal Distributions (TNDs)

The variational learning approach can be used for estimating the posterior distribution of the weights given data by minimizing the Kullback-Leibler (KL) divergence between a proposed approximate distribution q_{ϕ}(Ω) (e.g., TNDs over convolutional kernels) and the true posterior distribution of the weights.

$$\text{?} \qquad ( 3 )$$

$$\text{?} \text{indicates text missing or illegible when filed}$$

where E=E_{qϕ(Ω)}. In addition, [symbol] (ϕ;y| [symbol] ) denotes the (variational) or evidence lower bound (ELBO) as:

[symbol]

(ϕ;y| [symbol] )=E(log p(y| [symbol] ,Ω))−KL(q_{ϕ}(Ω)∥p(Ω)). (4)

An optimal approximation to posterior distribution is obtained by maximizing the ELBO objective function, which includes two parts: the expected log-likelihood of the training data given the weights, and a regularization term. The expected log-likelihood is defined as a multivariate Gaussian with the mean and covariances of the approximate distribution q_{ϕ}(Ω) through the network.

Propagation of the First Two Moments

Without loss of generality, propagation of means and covariances of the approximate distribution q_{ϕ}(Ω) through a CNN with one convolutional layer (C=1) followed by the activation function, one max-pooling and one fully-connected layer (L=1) is demonstrated in FIG. 1. The goal is to obtain the mean and covariance of the likelihood distribution, p(y| [symbol] ,Ω), which represent the network's prediction (mean) and the uncertainty associated with it (variances in the covariance matrix).

Convolutional Layer. The convolution operation between a set of kernels and the input tensor is formulated as a matrix-vector multiplication. We first form sub-tensors [symbol] _{i:i+r}_{₁}_{-1,j:j+r}_{₂}₋₁ from the input tensor [symbol] , having the same size as the kernels [symbol] ^{(k}^{_{c}}⁾ϵ [symbol] ^{r}^{₁}^{×r}^{₂}^{×K}. These sub-tensors are subsequently vectorized and arranged as the rows of a matrix \tilde{X}. Thus, we have [symbol] * [symbol] ^{(k}^{_{c}}⁾⇔\tilde{X} vec( [symbol] ^{(k}^{_{c}}⁾), where * denotes the convolution operation.

The output of the convolution is denoted as the k_{c}^{th} kernel with the input by z^{(k}^{_{c}}⁾=\tilde{X} vec( [symbol] ^{(k}^{_{c}}⁾). The kernels are endowed with TNDs, which are equivalent to multivariate Gaussian distribution over the vectorized kernels, e.g., vec( [symbol] ^{(k}^{_{c}}⁾+ [symbol] (m^{(k}^{_{c}}⁾,Σ^{(k}^{_{c}}⁾), where m^{(k}^{_{c}}⁾=vec(M^{(k}^{_{c}}⁾ and Σ^{(k}^{_{c}}⁾=U^{(1,k}^{_{c}}⁾⊗U^{(2,k}^{_{c}}⁾⊗U^{(3,k}^{_{c}}⁾. It follows that z^{(k}^{_{c}}⁾˜ [symbol] (\tilde{X}m^{(k}^{_{c}}⁾,\tilde{X}Σ^{(k}^{_{c}}⁾\tilde{X}^{T}).

Non-linear Activation Function: The mean and covariance passing through the non-linear activation function ψ can be approximated using a Taylor series (first-order approximation). Let gᵢ^{(k}^{_{c}}⁾=ψ[zᵢ^{(k}^{_{c}}⁾] be the element-wise i^{th} output of ψ. This, elements of μ_{g}(k_{c}) and Σ_{g}(k_{c}) are derived as:

$$\text{?}$$

$$\text{?} \text{indicates text missing or illegible when filed}$$

where i≠j.

Max-Pooling Layer. For the max-pooling, μₚ(k_{c})=pool(μ_{g}(k_{c})) and Σₚ(k_{c})=co-pool(Σ_{g}(k_{c})), where pool represents the max-pooling operation on the mean and co-pool represents down-sampling the covariance, e.g., where only the rows and columns of Σ_{g}(k_{c}) corresponding to the pooled means are kept.

Fully-Connected Layer. The output tensor of the max-pooling layer, e.g., [symbol] (as shown in FIG. 1) is vectorized to form an input vector b to the fully-connected layer, such that b=[p^{(1)T}, . . . , p^{(K}^{_{c}}^{)T}]^{T}. The mean and covariance matrix of b are given by:

$$\text{?}$$

$$\text{?} \text{indicates text missing or illegible when filed}$$

Let wₕ˜ [symbol] (mₕ,Σₕ) the weight vectors of the fully-connected layer, where h=1, . . . , H, and H is the number of output neurons. It should be noted that fₕ is the product of two independent random vectors b and wₕ. Let f be the output vector of the fully-connected layer, then we can prove that the elements of μ_{f} and Σ_{f} are derived as:

E[fₕ]=mₕ^{T}μ_{b},

Var[fₕ]=tr(Σₕ,Σ_{b})+mₕ^{T}Σ_{b}mₕ+μ_{b}^{T}Σₕμ_{b},

Cov[fₕ_{ₛ},fₕ_{₁}]=mₕ_{ₛ}^{T}Σ_{b}mₕ_{₁}, i≠j. (7)

Assuming diagonal covariance matrices for the distributions defined over network weights, e.g., vec(W^{(k}^{_{c}}⁾)˜N(vec(M^{(k}^{_{c}}⁾;σᵣ_{₁}_{,k}_{_{c}}²I,σᵣ_{₂}_{,k}_{_{c}}²I,σ_{K,k}_{_{c}}²I), and wₕ˜(mₕ;σₕ²I), N independently and identically distributed (iid) data points and using M Monte Carlo samples to approximate the expectation by a summation, the ELBO objective function is reformulated as:

$$\text{?}$$

$$\text{?} \text{indicates text missing or illegible when filed}$$

where n_{f} is the length of wₕ. The last two terms in Equation (8) are the result of the KL-divergence between prior and approximate distributions and act as regularizations. Equation 8 can be extended to multiple layers as well as to different network types (e.g., recurrent neural networks).

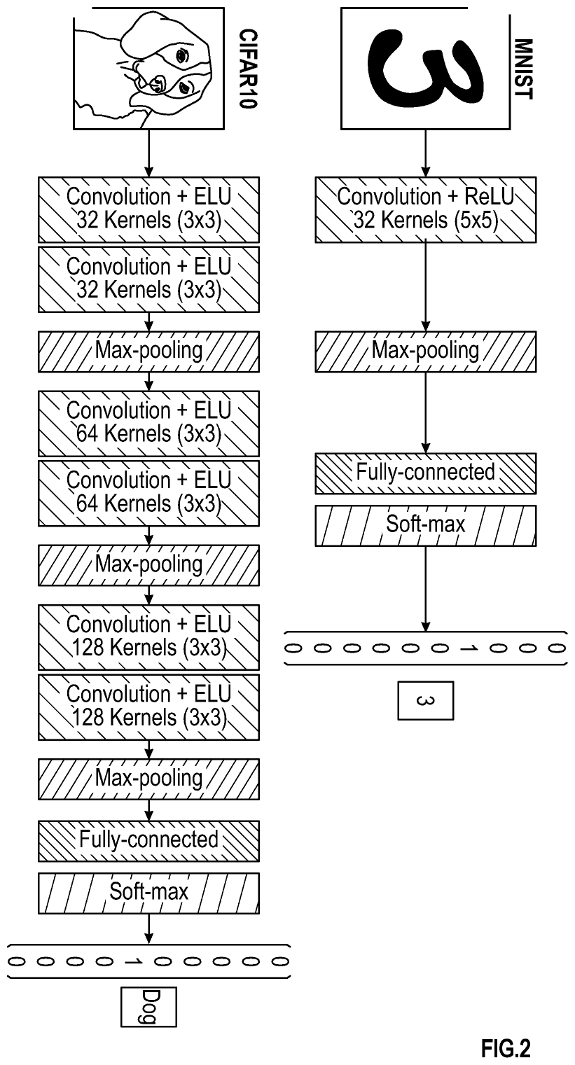

Although the previous discussion with respect to FIG. 1 illustrates an example of embodiments using a simple convolutional neural network, the principles of the present disclosure apply equally to convolutional neural networks with additional layers as well as sequence models, including recurrent neural networks (RNNs) and long-short-term memory networks (LSTMs). Examples of more complicated implementations are illustrated in FIG. 2, where a first convolutional neural network is illustrated for recognizing the number “3” in MNIST handwritten data set and a picture of a dog in the CIFAR-10 data set.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X, Y, or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, we claim:

1. A system, comprising:
a computing device comprising a processor and a memory;
a convolutional neural network stored in the memory, the convolutional neural network comprising a plurality of non-linear perceptrons, each non-linear perceptron comprising a non-linear activation function; and
machine readable instructions stored in the memory that, when executed by the processor, cause the computing device to at least:
apply a respective tensor normal distribution to each of a plurality of convolutional kernels of the convolutional neural network, wherein the respective tensor normal distribution captures a correlation and a variance heterogeneity of each of the plurality of the convolutional kernels;
approximate the mean and covariance of each respective tensor normal distribution passing through the non-linear activation function of each non-linear perceptron;
perform a max-pool operation on a plurality of outputs of the plurality of non-linear perceptrons to generate an output tensor;
vectorize the output tensor to create an input vector for a fully-connected layer of the convolutional neural network;
generate an output vector using the fully-connected layer; and
compute a mean matrix and a covariance matrix for the output vector.

2. The system of claim 1, wherein the machine-readable instructions, when executed by the processor, further cause the computing device to at least:
supply the output vector to a softmax function to make a prediction; and
compute a confidence in the prediction based at least in part on the mean matrix and the covariance matrix of the output vector.

3. The system of claim 1, wherein the machine-readable instructions that cause the computing device to approximate the mean and covariance of each respective tensor normal distribution passing through the non-linear activation function of each non-linear perceptron utilize a Taylor series first-order approximation.

4. The system of claim 1, wherein the machine-readable instructions that cause the computing device to approximate the mean and covariance of each respective tensor normal distribution passing through the non-linear activation function of each non-linear perceptron utilize a Monte Carlo expansion.

5. The system of claim 1, wherein the machine-readable instructions that cause the computing device to approximate the mean and covariance of each respective tensor normal distribution passing through the non-linear activation function of each non-linear perceptron utilize a wavelet.

6. A method, comprising
applying a respective tensor normal distribution to each of a plurality of convolutional kernels of a convolutional neural network, wherein the respective tensor normal distribution captures a correlation and a variance heterogeneity of each of the plurality of convolutional kernels;
approximating the mean and covariance of each respective tensor normal distribution passing through the non-linear activation function of each non-linear perceptron;
performing a max-pool operation on a plurality of outputs of the plurality of non-linear perceptrons to generate an output tensor;
vectorizing the output tensor to create an input vector for a fully-connected layer of the convolutional neural network;
generating an output vector using the fully-connected layer; and
computing a mean matrix and a covariance matrix for the output vector.

7. The method of claim 6, further comprising:
supplying the output vector to a softmax function to make a prediction; and
computing a confidence in the prediction based at least in part on the mean matrix and the covariance matrix of the output vector.

8. The method of claim 6, wherein approximating the mean and covariance of each respective tensor normal distribution passing through the non-linear activation function of each non-linear perceptron is based at least in part on a Taylor series first-order approximation.

9. The method of claim 6, wherein approximating the mean and covariance of each respective tensor normal distribution passing through the non-linear activation function of each non-linear perceptron is based at least in part on a Monte Carlo expansion.

10. The method of claim 6, wherein approximating the mean and covariance of each respective tensor normal distribution passing through the non-linear activation function of each non-linear perceptron is based at least in part on a wavelet.

11. A non-transitory, computer-readable medium comprising machine-readable instructions that, when executed by a processor of a computing device, cause the computing device to at least:
apply a respective tensor normal distribution to each of a plurality of convolutional kernels of a convolutional neural network, wherein the respective tensor normal distribution captures a correlation and a variance heterogeneity of each of the plurality of convolutional kernels;
approximate the mean and covariance of each respective tensor normal distribution passing through the non-linear activation function of each non-linear perceptron;
perform a max-pool operation on a plurality of outputs of the plurality of non-linear perceptrons to generate an output tensor;
vectorize the output tensor to create an input vector for a fully-connected layer of the convolutional neural network;
generate an output vector using the fully-connected layer; and
compute a mean matrix and a covariance matrix for the output vector.

12. The non-transitory, computer-readable medium of claim 11, wherein the machine-readable instructions, when executed by the processor, further cause the computing device to at least:
supply the output vector to a softmax function to make a prediction; and
compute a confidence in the prediction based at least in part on the mean matrix and the covariance matrix of the output vector.

13. The non-transitory, computer-readable medium of claim 11, wherein the machine-readable instructions that cause the computing device to approximate the mean and covariance of each respective tensor normal distribution passing through the non-linear activation function of each non-linear perceptron utilize a Taylor series first-order approximation.

14. The non-transitory, computer-readable medium of claim 11, wherein the machine-readable instructions that cause the computing device to approximate the mean and covariance of each respective tensor normal distribution passing through the non-linear activation function of each non-linear perceptron utilize a Monte Carlo expansion.

15. The non-transitory, computer-readable medium of claim 11, wherein the machine-readable instructions that cause the computing device to approximate the mean and covariance of each respective tensor normal distribution passing through the non-linear activation function of each non-linear perceptron utilize a wavelet.
